(19) United States
(12) Patent Application Publication
(10) Pub. No.: US 2025/0133508 A1
(43) Pub. Date: Apr. 24, 2025

(54) SYSTEM AND METHOD FOR MANAGING ENERGY CONSUMPTION IN A WIRELESS NETWORK

(71) Applicant: T-Mobile Innovations LLC, Overland Park, KS (US)

(72) Inventors: Roopesh Kumar POLAGANGA, Bothell, WA (US); Sanjay WAJE, Plano, TX (US)

(21) Appl. No.: 18/491,999

(22) Filed: Oct. 23, 2023

(51) Int. Cl. H04W 52/24

(52) U.S. Cl. CPC H04W 52/241; H04W 52/243

(57) ABSTRACT

Systems and methods are provided for managing power usage in a wireless network. Methods include monitoring a channel quality of communications between an access node and a wireless device. Methods further include determining that there is a trend in channel quality changing over time. Methods further include adjusting a power output from the access node based at least in part on the determined trend.

### TECHNICAL BACKGROUND

As wireless networks evolve and grow, there are ongoing challenges in communicating data across different types of networks. For example, a wireless network may include one or more access nodes, such as base stations, for providing wireless voice and data service to wireless devices in various coverage areas of the one or more access nodes. Often, there are obstructions between the access nodes and the wireless devices. These obstructions can cause reduction in signal strength and quality of service. The access nodes typically radiate at full power at all times to ensure good signal quality and end-user quality of service. At times, full power is more than is necessary to maintain a useful quality of service. This leads to wasted energy powering the radios to full strength when they don't need to be at full power. A method of better controlling the power output to reduce wasted energy is needed.

### OVERVIEW

Examples described herein include methods and systems for managing energy consumption in wireless networks, specifically, for adjusting the power output from an access node based on trends in the channel quality. An exemplary method includes monitoring a channel quality of communications between an access node and a wireless device. The method further includes determining that there is a trend in the channel quality changing over time. The method further includes adjusting a power output from the access node based at least in part on the determining that there is a trend in the channel quality over time.

Another exemplary embodiment includes a system configured with an access node including at least one electronic processor configured to perform operations. The operations include monitoring a channel quality of communications between an access node and a wireless device. The operations further include determining that there is a trend in the channel quality changing over time. The operations further include adjusting a power output from the access node based at least in part on the determining that there is a trend in the channel quality over time.

Another exemplary embodiment includes monitoring a channel quality of communications between an access node and a wireless device. The method further includes determining that there is a trend in the channel quality changing over time. The method further includes increasing a power output from the access node based at least in part on the determining that the trend in the channel quality over time is trending down. The method further includes decreasing a power output from the access node based at least in part on the determining that the trend in the channel quality over time is trending up.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates an exemplary processing node in accordance with various aspects of the present disclosure;

FIG. 3 illustrates an exemplary access node in accordance with various aspects of the present disclosure;

FIG. 4 illustrates an exemplary process flow for managing energy consumption in a wireless network;

FIG. 5 illustrates an exemplary process flow for managing energy consumption in a wireless network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a cellular or wireless network may be provided by an access node. The access node may utilize one or more antennas to communicate with wireless devices. Methods like beamforming are used to focus this radiated power in specific directions. The Radio Access Network (RAN) of a wireless provider consumes the most electrical energy of all the parts of the wireless network. Access nodes are capable of adjusting the power output of their radios, but generally they broadcast at full power. This can help prevent signal degradation due to things like obstructions or inclement weather, but often leads to using more power than necessary. It takes energy from the electrical grid to provide the wireless network. When the access node broadcasts at a higher level than necessary, it wastes energy. One energy saving method may include powering off some radios for very short time periods (even as short as microseconds) in the hope that cumulatively, the savings will be worth it. Another may be to power down certain antenna panels during low usage times of the day. For a wireless provider with thousands of access nodes broadcasting to millions of wireless devices, the wasted energy adds up. As good corporate citizens, wireless providers should seek to minimize wasted energy. There is an opportunity to dynamically reduce radiated power with changes in covered area while maintaining the same user experience. Some changes in the covered area can be due to foliage changes due to seasonality or even due to construction changes.

One common source of obstruction for wireless signals is foliage. The leaves on trees can interfere with wireless signals. In large parts of the world, the leaves on trees follow a predictable pattern where they start to grow in the spring, are at their peak in the summer, start to reduce as they fall in the autumn and then are absent in the winter. All else being equal, the average obstruction level for wireless signals would therefore be highest in the summer, reduce over the autumn, be lowest in the winter and rise in the spring. Wireless providers can take advantage of these predictable trends in obstruction levels by decreasing power output of access nodes as the obstruction level decreases in the autumn, run at a lower power level through the winter, increase the power level as the leaves grow during the spring and maintain a higher power level in the summer as the foliage obstruction is at its highest level.

These trends are relatively predictable, but it would be too imprecise to simply follow a calendar and blindly change power output based on the calendar alone. The described methods and systems can improve the efficiency of the wireless network by dynamically reducing power when possible and increasing power as needed.

Access nodes, including gNBs, store a great deal of information about the user equipment wireless device and the channel quality between the wireless device and the access node. This is often stored in the Location Session Records (LSR). The wireless device regularly reports the channel quality metrics, including the corresponding location of the wireless device. These reported channel quality metrics may include but are not limited to: Channel Quality Indicator (CQI), Rank Indicator (RI), Reference Signal Received Power (RSRP), Reference Signal Received Quality (RSRQ), and Signal to Noise Interference Ratio (SNIR). The channel quality metrics can be on the cell level of granularity.

The trends in channel quality can be mapped on a graph where improving channel quality would have a positive slope and reducing quality would have a negative slope. The steepness of the slope would indicate the strength of the trend in channel quality. For an operator defined duration sliding window, for example two months, if the average/median change in slope is positive, the operator could gradually reduce the radiated power and keep monitoring. If the average/median change in slope is negative, gradually increase the radiated power and keep monitoring. The increase or decrease in radiated power may be made at a pre-determined rate, may be calculated based on the strength of the trend in channel quality, or may be defined in any other useful manner. The operator can choose to change the power based on a mere positive or negative slope or when the slope reaches a certain threshold. The operator can also choose the duration of the sliding window to be of any useful duration.

Another way of determining when or how much to change the power output may include using the wireless device power class. For example, a PC1.5 device may see a different threshold for triggering and a different rate of power output change than a PC2 device. Another way of determining when or how much to change the power output may include using the wireless device type. For example, the wireless device could be classified as one of the following: NB-IoT, Cat-M1, or mobile phone, for example, and the thresholds for triggering and rate of change for the power output change may depend, in part, on this wireless device type classification.

The operator may also be able to take advantage of Artificial Intelligence (AI) or Machine Learning (ML) to improve the process of determining when and by how much to change the output power. For example, the system may monitor channel quality data over many years and may learn to expect seasonal changes at certain times of the year, for example learning that the trees start to fill out in May leading to a negative trend in channel quality. The system may learn to expect the channel quality to change at different rates at different times of year and at different location. For example, fall in the north occurs much earlier than it does in the south and the seasonal change may also occur much quicker. This seasonal learning may be applicable to both foliage-type interference as well as seasonality in weather patterns. Additionally, the system may be fed weather forecasting information and learn that when inclement weather approaches, the channel quality will trend downwards and therefore the power output will need to be increased. The opposite may also be true when the forecast is for clear weather, the system learns that the channel quality is likely to trend upwards and therefore the power output may be reduced. The system may also learn the seasonal weather patterns and become better at predicting when to increase or decrease the power output of the access nodes.

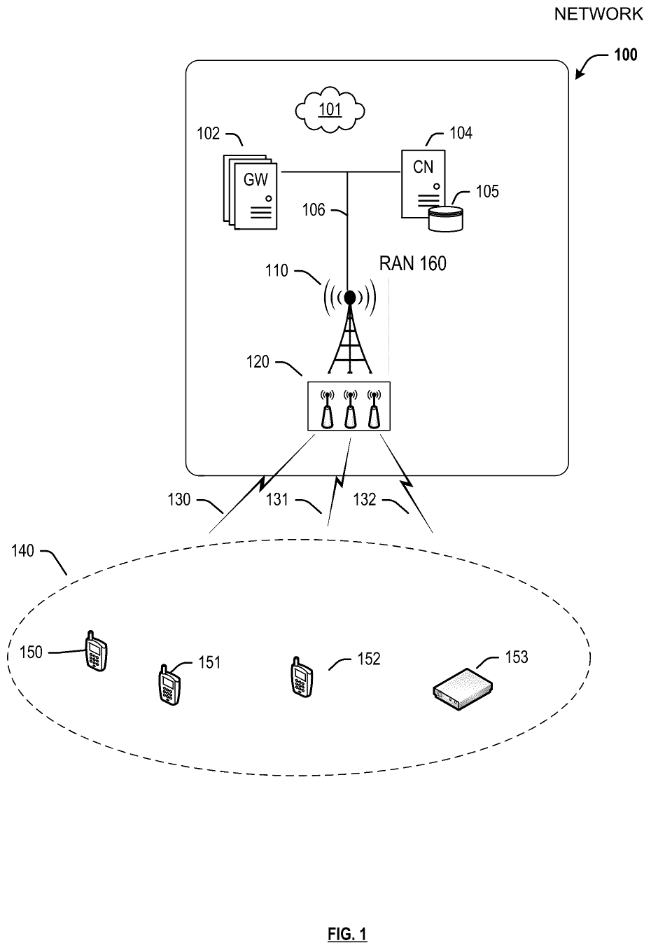

FIG. 1 depicts an exemplary system 100 for providing wireless networks. System 100 includes a communication network 101, gateway node(s) 102, controller node 104, access node 110, and wireless devices 150-153. Access node 110 can be any network node configured to provide communication between wireless devices 150-153 and communication network 101, including standard access nodes and/or short range, low power, small access nodes.

For instance, access node 110 may include any standard access node, such as a macrocell access node, base transceiver station, a radio base station, an eNodeB device, an enhanced eNodeB device, a next generation or gigabit NodeB device (gNBs) in 5G networks, or the like. In other embodiments, access node 110 can be a small access node including a microcell access node, a picocell access node, a femtocell access node, or the like such as a home NodeB, home eNodeB or home gNodeB device. By virtue of comprising a plurality of antennae 120 as further described herein, access node 110 can deploy or implement different radio access technologies (RATs) such as 3G, 4G, 5G, sub-6G, mm-wave, as well as transmission modes including multiple-input-multiple-output (MIMO), single user MIMO (SU-MIMO), multi-user MIMO (MU-MIMO), etc. While three antennae are shown in the array 120, any number of antennae may be included in the array 120. Moreover, each of wireless devices 150-153 can also be equipped with a plurality of antennae enabling these different types of transmissions.

For example, each of wireless devices 150-153 may be capable of simultaneously communicating with access node 110 using combinations of antennae via 4G and 5G or any other RAT or transmission mode. For instance, MU-MIMO pairings and SU-MIMO pairings can be made by wireless devices 150-153. It is noted that any number of access nodes, antennae, MU-MIMO pools, and wireless devices can be implemented.

In operation, access node 110 (or any other entity within system 100) may be configured to execute a method including monitoring a channel quality of communications between an access node and a wireless device, determining that there is a trend in the channel quality changing over time, and adjusting a power output from the access node based at least in part on the determining that there is a trend in the channel quality changing over time.

The method may further include increasing the power output from the access node when the determining that there is a trend in the channel quality determines that the channel quality is trending down. The method may further include decreasing the power output from the access node when the determining that there is a trend in the channel quality determines that the channel quality is trending up. Additionally, the adjusting of the power output from the access node may also be based at least in part on a strength of the trend in channel quality changing over time. For example, if the channel quality trend drops significantly, the power output may be increased significantly as well. The reciprocal may also occur where the channel quality increases significantly leading to the power output being decreased significantly.

The method may further include determining a mobility factor of the wireless device, wherein the mobility factor indicates a likelihood that the wireless device is a mobile wireless device rather than a stationary wireless device and adjusting the power output from the access node based at least in part also on the mobility factor of the wireless device. Mobile devices may be affected by variable obstructions differently than stationary devices and therefore this method may take that into account. For example, a mobile phone is likely to have less powerful transceivers and may be more susceptible to channel quality degradation than a stationary wireless device with a more powerful transceiver such as a 5G home internet wireless device.

The method may further include determining a seasonal factor of the wireless device, wherein the seasonal factor indicates the likelihood that the channel quality is affected by seasonally occurring interference and adjusting the power output from the access node based at least in part also on the seasonal factor. The seasonal factor may account for seasonal interference such as vegetation and stormy weather. As discussed above, vegetation tends to increase through the spring, peak in the summer and reduce in the fall. The seasonal factor would account for that. Additionally, storm patterns may have tendencies that may be tracked by season as well. For example, certain parts of the country may tend to have thunderstorms in the afternoons through the summer due to high humidity and convective heating.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 communicates with gateway node 102 and controller node 104 via communication link 106. Access node 110 may communicate with other access nodes (not shown) using a direct link such as an X2 link or similar.

Wireless devices 150-153 may be any device, system, combination of devices, or other such communication platform capable of communicating wirelessly with access node 110 using one or more frequency bands deployed therefrom. Each of wireless devices 150-153 may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via access node 110. Other types of communication platforms are possible.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 150-153, etc. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication link 106 can use various communication media, such as air, space, metal, optical fiber, or some other signal propagation path—including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications link 106 may include S1 communications links. Other wireless protocols can also be used. Communication link 106 can be a direct link or might include various equipment, intermediate components, systems, and networks. Communication link 106 may comprise many different signals sharing the same link.

Gateway node 102 can be any network node configured to interface with other network nodes using various protocols. Gateway node 102 can communicate user data over system 100. Gateway node 102 can be a standalone computing device, computing system, or network component, and can be accessible, for example, by a wired or wireless connection, or through an indirect connection such as through a computer network or communication network. For example, gateway node 102 can include a serving gateway (SGW) and/or a public data network gateway (PGW), a user plane function (UPF), etc. One of ordinary skill in the art would recognize that gateway node 102 is not limited to any specific technology architecture, such as Long Term Evolution (LTE) or 5G NR, and can be used with any network architecture and/or protocol.

Gateway node 102 can comprise a processor and associated circuitry to execute or direct the execution of computer-readable instructions to obtain information. Gateway node 102 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Gateway node 102 can receive instructions and other input at a user interface.

Controller node 104 can be any network node configured to communicate information and/or control information over system 100. Controller node 104 can be configured to transmit control information associated with a handover procedure. Controller node 104 can be a standalone computing device, computing system, or network component, and can be accessible, for example, by a wired or wireless connection, or through an indirect connection such as through a computer network or communication network. For example, controller node 104 can include a mobility management entity (MME), a session management function (SMF), a Home Subscriber Server (HSS), a Policy Control and Charging Rules Function (PCRF), an authentication, authorization, and accounting (AAA) node, a rights management server (RMS), a subscriber provisioning server (SPS), a policy server, etc. One of ordinary skill in the art would recognize that controller node 104 is not limited to any specific technology architecture, such as Long Term Evolution (LTE) or 5G NR, and can be used with any network architecture and/or protocol.

Controller node 104 can comprise a processor and associated circuitry to execute or direct the execution of computer-readable instructions to obtain information. Controller node 104 can retrieve and execute software from storage, which can include a disk drive, a flash drive, memory circuitry, or some other memory device, and which can be local or remotely accessible. In an exemplary embodiment, controller node 104 includes a database 105 for storing correlations of transmission types with antenna configurations, and so on. This information may be requested by or shared with access node 110 via communication link 106, X2 connections, and so on. The software comprises computer programs, firmware, or some other form of machine-readable instructions, and may include an operating system, utilities, drivers, network interfaces, applications, or some other type of software, and combinations thereof. Controller node 104 can receive instructions and other input at a user interface.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 100 may be, comprise, or include computers systems and/or processing nodes. This includes, but is not limited to: access node 110, controller node 104, and/or network 101.

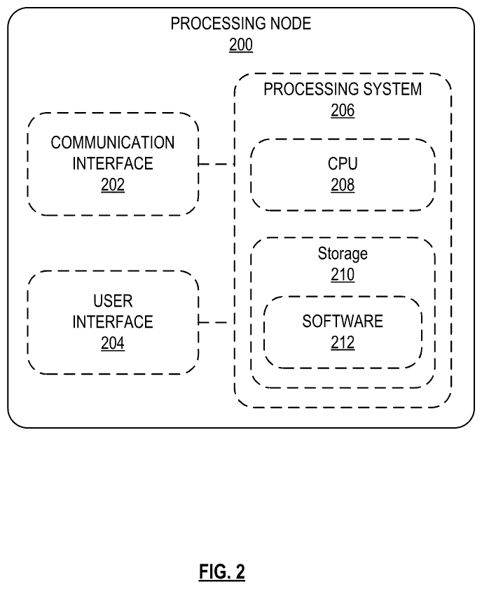

FIG. 2 depicts an exemplary processing node 200 for providing wireless service in a wireless network. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200.

In an exemplary embodiment, software 212 can include instructions for monitoring a channel quality of communications between an access node and a wireless device, determining that there is a trend in the channel quality changing over time, and adjusting a power output from the access node based at least in part on the determining that there is a trend in the channel quality changing over time.

The instructions may further include increasing the power output from the access node when the determining that there is a trend in the channel quality determines that the channel quality is trending down. The instructions may further include decreasing the power output from the access node when the determining that there is a trend in the channel quality determines that the channel quality is trending up. Additionally, the adjusting of the power output from the access node may also be based at least in part on a strength of the trend in channel quality changing over time. For example, if the channel quality trend drops significantly, the power output may be increased significantly as well. The reciprocal may also occur where the channel quality increases significantly leading to the power output being decreased significantly.

The instructions may further include determining a mobility factor of the wireless device, wherein the mobility factor indicates a likelihood that the wireless device is a mobile wireless device rather than a stationary wireless device and adjusting the power output from the access node based at least in part also on the mobility factor of the wireless device. Mobile devices may be affected by variable obstructions differently than stationary devices and therefore these instructions may take that into account.

The instructions may further include determining a seasonal factor of the wireless device, wherein the seasonal factor indicates the likelihood that the channel quality is affected by seasonally occurring interference and adjusting the power output from the access node based at least in part also on the seasonal factor. The seasonal factor may account for seasonal interference such as vegetation and stormy weather. As discussed above, vegetation tends to increase through the spring, peak in the summer and reduce in the fall. The seasonal factor would account for that. Additionally, storm patterns may have tendencies that may be tracked by season as well. For example, certain parts of the country may tend to have thunderstorms in the afternoons through the summer due to high humidity and convective heating.

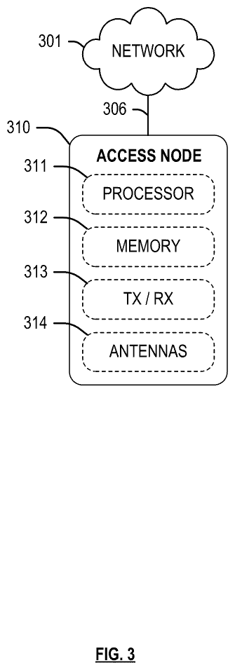

FIG. 3 depicts an exemplary access node 310 for providing wireless service in wireless networks. Access node 310 is configured as an access point for providing network services from network 301 to end-user wireless devices such as wireless devices 150-153 in FIG. 1. Access node 310 is illustrated as comprising a processor 311, a memory 312 for storing logical modules that perform operations described herein, and one or more transceivers 313 for transmitting and receiving signals via antennae 314. Combination of antennae 314 and transceivers 313 are configured to deploy one or more radio air interfaces using different RATs, frequencies, and/or operating modes. Additional transceivers and antennae may be incorporated in order to deploy 4G, 5G, mm-wave, SU-MIMO, MU-MIMO or massive MU-MIMO data streams to wireless devices attached to access node 310, as well as to facilitate communication with other network nodes on network 301. Further, access node 310 is communicatively coupled to network 301 via communication interface 306, which may be any wired or wireless link as described above. The one or more antennae 314 can include any combination of: antennae associated with different radio access technologies (RATs) (including 3G, 4G, 5G, 5G sub 6G, 5G millimeter wave), antennae associated with different arrays (including 2×2, 4×2, 4×4, 8×8, 16×16, 32×32, 64×64, 128×128, and so on), and beamforming antennae.

In an exemplary embodiment, memory 312 can include instructions for monitoring a channel quality of communications between an access node and a wireless device, determining that there is a trend in the channel quality changing over time, and adjusting a power output from the access node based at least in part on the determining that there is a trend in the channel quality changing over time.

The instructions may further include increasing the power output from the access node when the determining that there is a trend in the channel quality determines that the channel quality is trending down. The instructions may further include decreasing the power output from the access node when the determining that there is a trend in the channel quality determines that the channel quality is trending up. Additionally, the adjusting of the power output from the access node may also be based at least in part on a strength of the trend in channel quality changing over time. For example, if the channel quality trend drops significantly, the power output may be increased significantly as well. The reciprocal may also occur where the channel quality increases significantly leading to the power output being decreased significantly.

The instructions may further include determining a mobility factor of the wireless device, wherein the mobility factor indicates a likelihood that the wireless device is a mobile wireless device rather than a stationary wireless device and adjusting the power output from the access node based at least in part also on the mobility factor of the wireless device. Mobile devices may be affected by variable obstructions differently than stationary devices and therefore these instructions may take that into account.

The instructions may further include determining a seasonal factor of the wireless device, wherein the seasonal factor indicates the likelihood that the channel quality is affected by seasonally occurring interference and adjusting the power output from the access node based at least in part also on the seasonal factor. The seasonal factor may account for seasonal interference such as vegetation and stormy weather. As discussed above, vegetation tends to increase through the spring, peak in the summer and reduce in the fall. The seasonal factor would account for that. Additionally, storm patterns may have tendencies that may be tracked by season as well. For example, certain parts of the country may tend to have thunderstorms in the afternoons through the summer due to high humidity and convective heating.

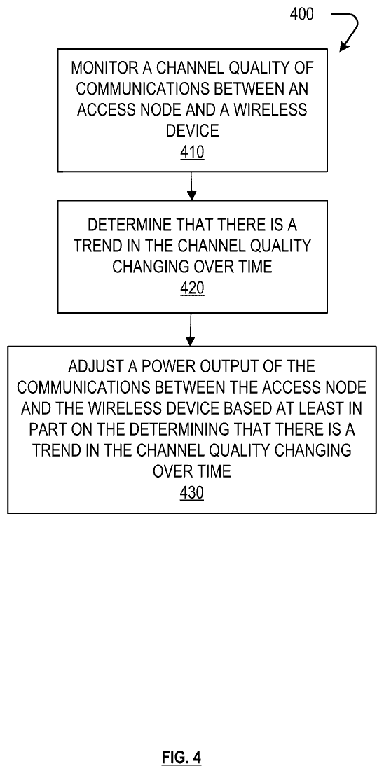

FIG. 4 illustrates an exemplary method 400 for managing power usage in a wireless network. Method 400 may be performed by any suitable combination of processors, for example a processor contained in an access node such as access node 110, 310. In other embodiments, the method can be implemented with any suitable network element, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a channel quality between an access node and a wireless device is monitored. In step 420, it is determined that there is a trend in the channel quality changing over time. In step 430, a power output from the access node is adjusted based at least in part on the determining that there is a trend in the channel quality changing over time.

Method 400 may include the optional step of increasing the power output from the access node when the determining that there is a trend in the channel quality determines that the channel quality is trending down. Method 400 may include the optional step of decreasing the power output from the access node when the determining that there is a trend in the channel quality determines that the channel quality is trending up. Method 400 may also factor the strength of the trend in the change over time of the channel quality when adjusting the power output from the access node.

Method 400 may include optional steps of determining a mobility factor of the wireless device, wherein the mobility factor indicates the likelihood that the wireless device is a mobile wireless device rather than a stationary wireless device; and wherein the adjusting the power output from the access node is also based at least in part on the mobility factor of the wireless device.

Method 400 may include optional steps of determining a seasonal factor of the wireless device, wherein the seasonal factor indicates the likelihood that the channel quality is affected by seasonally occurring interference; and wherein the adjusting the power output from the access node is also based at least in part on the seasonal factor of the wireless device. The seasonally occurring interference may be one or more of vegetation or stormy weather.

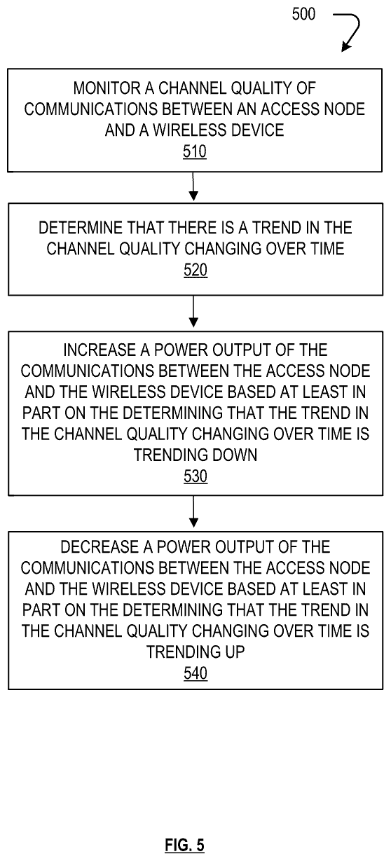

FIG. 5 illustrates an exemplary method 500 for managing power usage in a wireless network. Method 500 may be performed by any suitable combination of processors, for example a processor contained in an access node such as access node 110, 310. In other embodiments, the method can be implemented with any suitable network element, such as processing node 200. Although FIG. 5 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 500 begins in step 510 where a channel quality between an access node and a wireless device is monitored. In step 520, it is determined that there is a trend in the channel quality changing over time. In step 530, the power output from the access node is increased based at least in part of the determining that the trend in the channel quality changing over time is trending down. In step 540, the power output from the access node is decreased based at least in part of the determining that the trend in the channel quality changing over time is trending up. Method 500 may also factor in the strength of the trend in the change over time of the channel quality when increasing or decreasing the power output from the access node.

Method 500 may include optional steps of determining a mobility factor of the wireless device, wherein the mobility factor indicates the likelihood that the wireless device is a mobile wireless device rather than a stationary wireless device; and wherein the increasing or decreasing the power output from the access node is also based at least in part on the mobility factor of the wireless device.

Method 500 may include optional steps of determining a seasonal factor of the wireless device, wherein the seasonal factor indicates the likelihood that the channel quality is affected by seasonally occurring interference; and wherein the increasing or decreasing the power output from the access node is also based at least in part on the seasonal factor of the wireless device. The seasonally occurring interference may be one or more of vegetation or stormy weather.

Method 500 may include optional steps of determining a prediction factor of the wireless device, wherein the prediction factor indicates a prediction of the channel quality changing over time; wherein the prediction is based at least in part on one or more of a weather forecast, and a historical channel quality for a location of the wireless device; and wherein the increasing or decreasing the power output from the access node is also based at least in part on the prediction factor of the wireless device.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of managing power usage in a wireless network, the method comprising:
monitoring a channel quality of communications between an access node and a wireless device;
determining that there is a trend in the channel quality changing over time; and
adjusting a power output from the access node based at least in part on the determining that there is the trend in the channel quality changing over time.

2. The method of claim 1, wherein the adjusting the power output from the access node comprises increasing the power output from the access node when the determining that there is a trend in the channel quality determines that the channel quality is trending down.

3. The method of claim 1, wherein the adjusting the power output from the access node comprises decreasing the power output from the access node when the determining that that there is a trend in the channel quality determines that the channel quality is trending up.

4. The method of claim 1, wherein the adjusting the power output from the access node is also based at least in part on a strength of the trend in channel quality changing over time.

5. The method of claim 1, the method further comprising:
determining a mobility factor of the wireless device, wherein the mobility factor indicates a likelihood that the wireless device is a mobile wireless device rather than a stationary wireless device; and
wherein the adjusting the power output from the access node is also based at least in part on the mobility factor of the wireless device.

6. The method of claim 1, the method further comprising:
determining a seasonal factor of the wireless device, wherein the seasonal factor indicates a likelihood that the channel quality is affected by seasonally occurring interference; and
wherein the adjusting the power output from the access node is also based at least in part on the seasonal factor of the wireless device.

7. The method of claim 6, wherein the seasonally occurring interference comprises one or more of vegetation and stormy weather.

8. A system comprising:
an access node including at least one electronic processor configured to perform operations including:
monitoring a channel quality of communications between the access node and a wireless device;
determining that there is a trend in the channel quality changing over time; and
adjusting a power output from the access node based at least in part on the determining that there is the trend in the channel quality changing over time.

9. The system of claim 8, wherein the adjusting the power output from the access node comprises increasing the power output from the access node when the determining that that there is a trend in the channel quality determines that the channel quality is trending down.

10. The system of claim 8, wherein the adjusting the power output from the access node comprises decreasing the power output from the access node when the determining that that there is a trend in the channel quality determines that the channel quality is trending up.

11. The system of claim 8, wherein the adjusting the power output from the access node is also based at least in part on a strength of the trend in channel quality changing over time.

12. The system of claim 8, wherein the operations further comprise:
determining a mobility factor of the wireless device, wherein the mobility factor indicates a likelihood that the wireless device is a mobile wireless device rather than a stationary wireless device; and
wherein the adjusting the power output from the access node is also based at least in part on the mobility factor of the wireless device.

13. The system of claim 8, wherein the operations further comprise:
determining a seasonal factor of the wireless device, wherein the seasonal factor indicates a likelihood that the channel quality is affected by seasonally occurring interference; and
wherein the adjusting the power output from the access node is also based at least in part on the seasonal factor of the wireless device.

14. The system of claim 13, wherein the seasonally occurring interference comprises vegetation and stormy weather.

15. A method of managing power usage in a wireless network, the method comprising:
monitoring a channel quality of communications between an access node and a wireless device;
determining that there is a trend in the channel quality changing over time;
increasing a power output from the access node based at least in part on the determining that the trend in the channel quality changing over time is trending down; and
decreasing the power output from the access node based at least in part on the determining that the trend in the channel quality changing over time is trending up.

16. The method of claim 15, wherein increasing the power output from the access node is also based at least in part on a strength of the trend in the channel quality changing over time; and wherein decreasing the power output from the access node is also based at least in part on the strength of the trend in the channel quality changing over time.

17. The method of claim 15, the method further comprising:
determining a mobility factor of the wireless device, wherein the mobility factor indicates a likelihood that the wireless device is a mobile wireless device rather than a stationary wireless device; and
wherein the increasing or decreasing the power output from the access node is also based at least in part on the mobility factor of the wireless device.

18. The method of claim 15, the method further comprising:
determining a seasonal factor of the wireless device, wherein the seasonal factor indicates a likelihood that the channel quality is affected by seasonally occurring interference; and
wherein the increasing or decreasing the power output from the access node is also based at least in part on the seasonal factor of the wireless device.

19. The method of claim 18 wherein the seasonally occurring interference comprises vegetation and stormy weather.

20. The method of claim 15, the method further comprising:
determining a prediction factor, wherein the prediction factor indicates a prediction of the channel quality changing over time;
wherein the prediction is based at least in part on one or more of a weather forecast, and a historical channel quality for a location of the wireless device; and
wherein the increasing or decreasing the power output from the access node is also based at least in part on the prediction factor of the wireless device.
